(19) United States
(12) Patent Application Publication
(10) Pub. No.: US 2009/0287692 A1
(43) Pub. Date: Nov. 19, 2009

(54) INFORMATION PROCESSING APPARATUS AND METHOD FOR CONTROLLING THE SAME

(75) Inventor: Satoshi Ookuma, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/466,251

(22) Filed: May 14, 2009

(30) Foreign Application Priority Data
May 16, 2008 (JP) 2008-129492

(51) Int. Cl. G06F 17/30

(52) U.S. Cl. 707/5; 707/E17.017

(57) ABSTRACT

An information processing apparatus includes a holding unit configured to hold a plurality of indices associated with each document information stored in the storage unit, wherein each of the indices includes history information describing user information about users who have accessed each document information, and a user ranking unit allocates ranks to users who have accessed the document information that have been accessed by the search user in the past based on the history information included in a plurality of the indices. An index search unit searches the index held by the holding unit based on a keyword specified by the search user using the input unit, and a document ranking unit allocates ranks to the document information associated with the retrieved index, based on the user information about the access users in the index retrieved by the index search unit, and the user information about the users ranked by the user ranking unit.

### BACKGROUND OF THE INVENTION

1. Field of the Invention

The present invention relates to an information processing apparatus configured to store document information such as images and a method of controlling the same.

2. Description of the Related Art

A database for storing information such as images on documents often uses index associated with the information about each document in order to improve convenience in a document search.

An index generally includes a title of a document, an author, a creation date and time, or the like. A user may search information contained in the index and obtain a desired document from the retrieved index.

Recently, the information contained in the index has included a browse history of the document, a print history, access control information, and keyword information added to the document.

The browse history or the print history of the document accumulates information about when or who has browsed or printed the document. The information contained in the index is added when a document stored in a storage device of a copy machine or a document retained in a computer connected via a network is printed by a copy machine having a printer function. Such information is also added when the paper documents are stored in the storage device as electronic image data using a scanner.

Furthermore, the information contained in the index is appropriately updated when the documents in the storage device are browsed by a terminal such as a computer connected via a network or when the documents are directly viewed via the operation display unit of the copy machine which stores the documents.

However, in the database which stores a great number of documents, even when a user searches the database using keyword information of the index, the number of retrieved search results becomes enormous. Therefore, it may be difficult to narrow down a range of the documents to those desired by a user.

In this regard, Japanese Patent Application Laid-Open No. 2004-348626 discloses a method of specifying a group of users when a user wants to search for a document using keyword information. Weighting factors are allocated to the documents based on a use frequency of users belonging to the specified group who have used the keyword in the past, and the documents resulting from the search are sorted and displayed according to the weighting factor. Thus, a user can quickly retrieve a desired document.

However, when the documents resulting from the search are displayed by allocating the weighting factors based on the keyword use frequency, the users belonging to the same group as a user who conducts the search (hereinafter, referred to as a search user) do not always have the same interest or taste as the search user. Thus, a document desired by the search user is not necessarily displayed on a priority basis on the search results, which are obtained by applying weights. Therefore, the search user may not quickly obtain a desired document.

### SUMMARY OF THE INVENTION

The present invention is directed to an information processing apparatus and a method of controlling the same, by which document information desired by a user can be ranked at a higher level in the search results when information search is executed for the document information using a database.

According to an exemplary embodiment of the present invention, an information processing apparatus includes a storage unit configured to store document information, a holding unit configured to hold a plurality of indices associated with each document information stored in the storage unit, each of the indices including history information describing user information about users who have accessed each document information, an input unit configured to allow a search user to input information, a user ranking unit configured to allocate ranks to users, who have accessed the document information that have been accessed by the search user in the past, based on the history information included in a plurality of the indices, an index search unit configured to search the index held by the holding unit based on a keyword specified by the search user using the input unit, and a document ranking unit configured to allocate ranks to the document information associated with the index which is retrieved by the index search unit, based on the user information about the access users in the index retrieved by the index search unit and the user information about the users ranked by the user ranking unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating internal components of an image processing apparatus according to an exemplary embodiment of the present invention.

FIG. 2 is a conceptual diagram illustrating a structure of document data stored in a hard disk drive (HDD)

FIG. 3 is a schematic diagram illustrating an appearance of the operation unit of the image processing apparatus.

FIG. 4 illustrates a copy operation basic window displayed on the liquid crystal operation panel.

FIG. 5 illustrates a document data list window.

FIG. 6 illustrates a keyword search specifying window.

FIG. 7 is a flowchart illustrating a keyword search process according to a first exemplary embodiment.

FIG. 8 is a conceptual diagram illustrating data operation preceding keyword search according to the first exemplary embodiment.

FIG. 9 is a conceptual diagram illustrating data operation in a process for ranking the search results according to the first exemplary embodiment.

FIG. 10 illustrates a window for displaying search results obtained after the keyword search.

FIG. 11 illustrates a keyword search specifying window according to a second exemplary embodiment.

FIG. 12 is a flowchart illustrating a keyword search process according to the second exemplary embodiment.

FIG. 13 is a conceptual diagram illustrating data operation preceding the keyword search according to the second exemplary embodiment.

FIG. 14 illustrates a keyword search specifying window according to a third exemplary embodiment.

FIG. 15 illustrates a keyword search process according to the third exemplary embodiment.

FIG. 16 is a conceptual diagram illustrating data operation preceding the keyword search according to the third exemplary embodiment.

FIG. 17 is a conceptual diagram illustrating data operation executed in a process for ranking the search results according to the third exemplary embodiment.

### DETAILED DESCRIPTION OF THE EMBODIMENTS

Various exemplary embodiments, features, and aspects of the invention will be described in detail below with reference to the drawings.

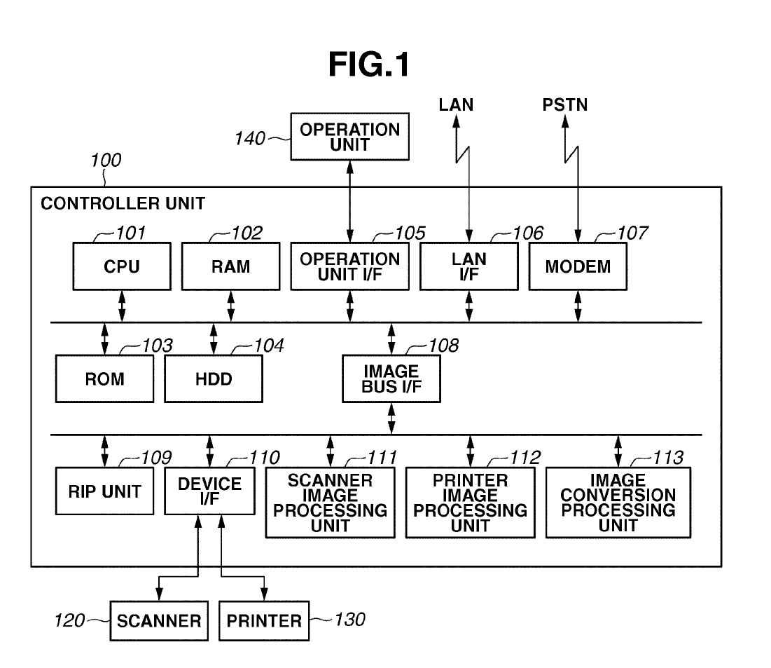

FIG. 1 is a block diagram illustrating an internal configuration of an image processing apparatus according to an exemplary embodiment of the present invention.

The image processing apparatus has a controller unit 100 that can be connected to a scanner 120, and a printer 130, as well as to networks such as a local area network (LAN) or a public switched telephone network (PSTN). The controller unit 100 also has a central processing unit (CPU) 101 for executing various control programs.

The CPU 101 activates a system based on a boot program stored in a read-only memory (ROM) 103 to read a control program stored in a hard-disk drive (HDD) 104 and execute a predetermined process using a random-access memory (RAM) 102 as a work area. The HDD 104 stores various kinds of control programs as well as image data (e.g., document data). In addition, the HDD 104 stores data read by the scanner 120 or document data obtained from external units via a LAN interface (I/F) 106 or a modem 107.

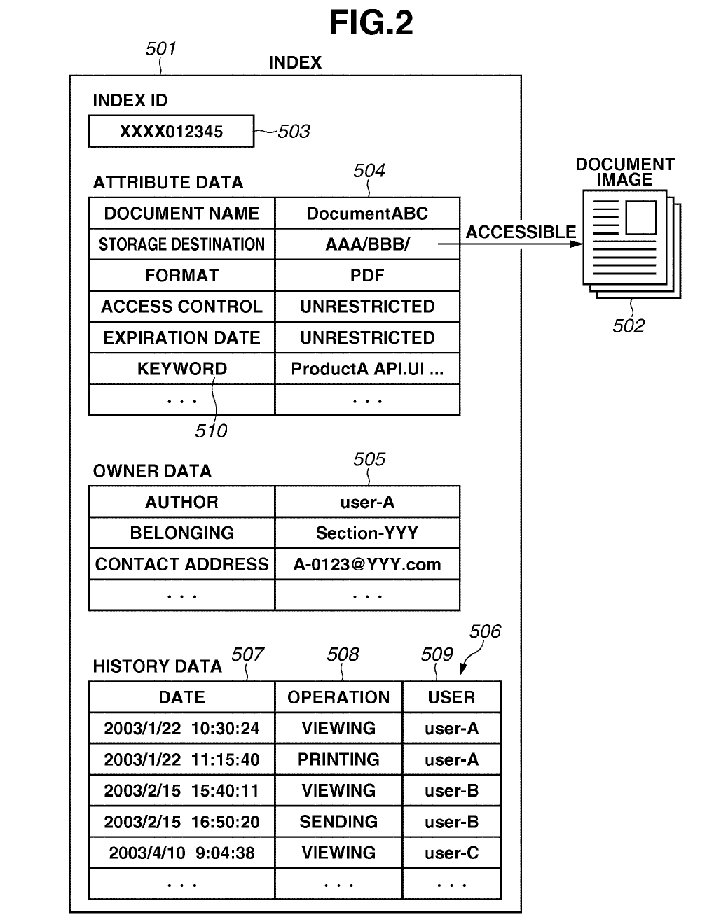

The document data contains an index, which is additional information about image data, as well as document images representing main image data, which will be described below referring to FIG. 2. The index is associated with the image data one by one, and contains various kinds of information about the image data.

An operation unit I/F 105 is an interface with an operation unit 140. The operation unit I/F 105 transmits image data to be displayed, to the operation unit 140, and transmits a signal generated by an input operation on the operation unit 140, to the CPU 101. The operation unit 140 includes a display section for displaying currently set status of each function relating to an image processing or an information input screen for inputting the setting information relating to each function, and an input section including keys for allowing a user to enter the setting information for each function.

The LAN I/F 106 is connected to a LAN to input/output information via a LAN. The modem 107 is connected to a PSTN to input/output information via a PSTN. An image bus I/F 108 is connected to an image bus and a system bus to convert data structures of both buses.

A raster image processor (RIP) unit 109 rasterizes page description language (PDL) codes received via the LAN I/F 106 into the bitmap images. A device I/F 110 connects the scanner 120 or the printer 130, which functions as an image input/output device, with the controller unit 100 to convert image data into a synchronous/asynchronous system.

A scanner image processing unit 111 corrects, processes, and edits input image data. A printer image processing unit 112 performs image correction of the printer 130 for the print output image data. An image conversion processing unit 113 performs processes such as a rotation process, a resolution correction, and a binary-to-multivalued conversion of the image data.

FIG. 2 is a conceptual diagram illustrating a structure of document data stored in the HDD 104.

The document data includes two types of data, which are, index 501 and document image 502. The document image 502 is an image data itself representing a document such as raster data or PDL data. The index 501 is associated with the document image 502, and contains various attribute information of the associated document image.

The document image 502 and the index 501 may be stored in a separate region or consecutive storage areas on the HDD 104. The index 501 internally holds destination information (i.e., a storage destination) linking to the document image 502, so as to access actual data of the document images based on that information. Typically, each index 501 is associated with one document image 502.

The index 501 includes four kinds of information, i.e., an index identification (ID) 503, attribute data 504, owner data 505, and history data 506. The index ID 503 is an ID number for uniquely identifying the index. A unique ID number is allocated when the index 501 is generated.

The attribute data 504 includes various information about the document itself of the document image 502 that is associated with the index 501. For example, the attribute data 504 includes a document name, a document storage destination (i.e., a link destination), an image format, and access control information for specifying accessible users, and an expiration date of the document. Further, the attribute data 504 includes information such as pieces of keyword information 510 representing a classification of the document. The keyword information 510 may be associated with contents, a summary, or a classification of the document image 502, and may be used as a search term for searching for the document.

The owner data 505 includes information about an owner of the document image 502. For example, the owner data 505 may include a name, a team or group to which the document owner belongs, or a contact point such as a telephone number and an e-mail address of the document owner. The history data 506 includes information about records of operation performed on the document image 502. For example, date and time data 507, details of operation 508, and user information 509 for identifying a user who has executed the operation are recorded as the history data 506 each time the document image 502 is viewed or printed.

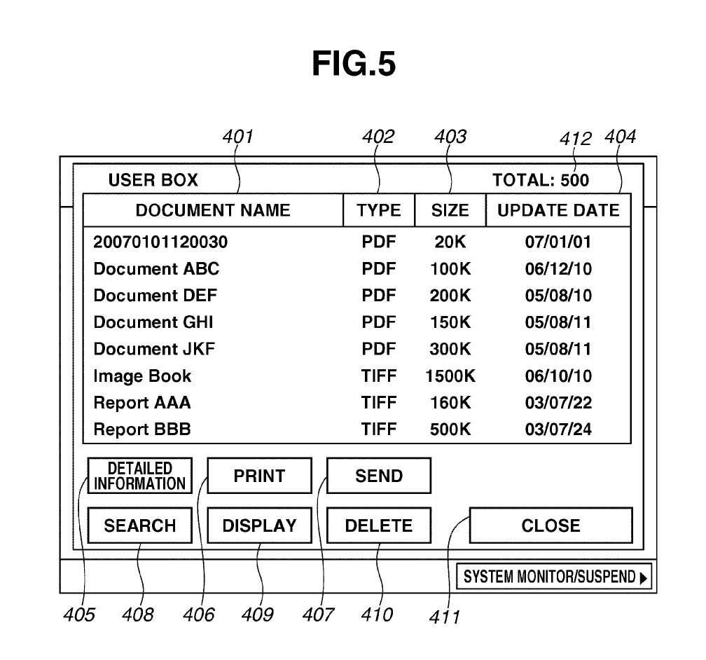

When the print button 406 (which will be described below referring to FIG. 5) is pressed to print out the document, historical information about the process is added to the history data 506. When the send button 407 (which will be described below referring to FIG. 5) is pressed to send out the document, historical information about the process is added to the history data 506. Similarly, when the display button 409 (which will be described below referring to FIG. 5) is pressed to display the document, historical information about the process is added to the history data 506.

By referencing this history data 506, the user can check what kind of operation is performed by whom and when for the document image 502 associated with the index 501.

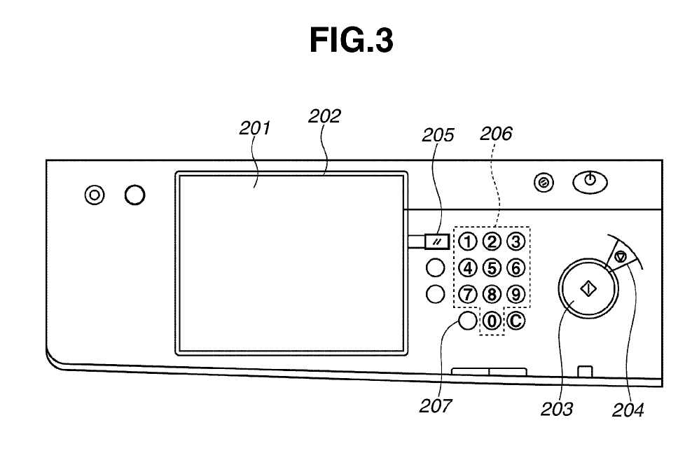

FIG. 3 is a schematic diagram illustrating an appearance of the operation unit 140 of the image processing apparatus.

A liquid crystal operation panel 202 is a liquid crystal display device having a touch panel sheet 201 on its surface. On the liquid crystal operation panel 202, an operation screen for performing various settings and setting information that has been input, are displayed. Various setting instructions can be entered when a user touches the operation instruction displayed on the operational panel 202 via the touch panel sheet 201.

When a user touches the liquid crystal operation panel 202 to give an instruction, the operation unit 140 detects position information of the area touched by the user and transmits the instruction corresponding to the touched area, to the CPU 101 via the operation unit I/F 105.

A start key 203 is a hard key for instructing initiation of reading operation by the scanner 120 or print operation by the printer 130. A stop key 204 is a hard key for issuing an instruction to stop the operation.

A reset key 205 is a key for clearing a current setting value and resetting to a standard setting value. A number keypad 206 has keys for entering numbers such as the number of copies. An ID key 207 is used to enter a user ID or password and log in to the device.

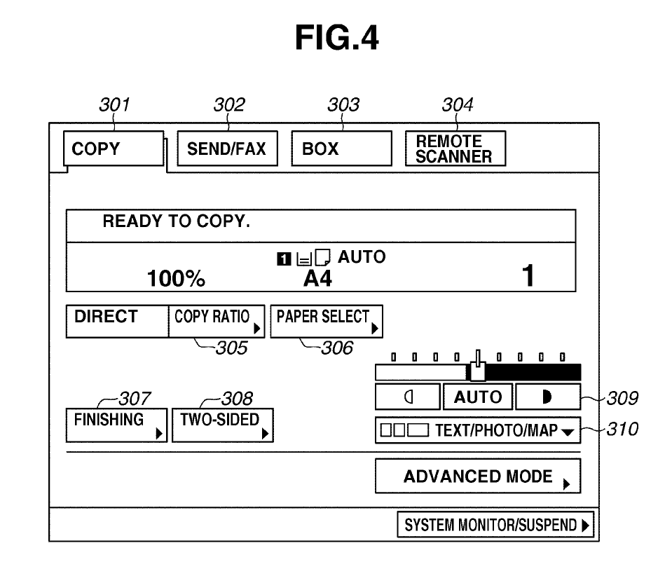

FIG. 4 is a diagram illustrating a copy operation basic window displayed on the liquid crystal operation panel 202. This window is a default window, which is displayed when the image processing apparatus is powered on.

The image processing apparatus is provided with four modes, i.e., a copy mode, a send mode, a box mode, and a scanner mode.

The copy mode is used to perform copy operation in which image data read and input by the scanner 120 is printed out by the printer 130. The send mode is used to transmit image data input from the scanner 120 or previously stored in the HDD 104 to a destination by means of e-mails or the like via a network such as a LAN or Internet.

The box mode is used to process (e.g., edit, print out, or send) the image data inside the box stored in the HDD 104. The box refers to a storage area in the HDD 104 that is allocated to each user to store the image data. The scanner mode is used to read and input the image data of the original using the scanner 120, and then, store the input image data in the box or transmit the input image data to other devices via a network such as a LAN. The aforementioned modes are switched by selecting the mode buttons 301 to 304.

The example illustrated in FIG. 4 shows a window, which is displayed when the copy mode is selected. A user may select or set up a zoom in/out, a paper size, a paper discharge option, a single/double-sided printing, a density, and an image quality mode using the buttons 305 to 310.

When the box mode button 303 is selected, a box list window (not shown in the drawing), which shows a list of information about the boxes allocated to each user, is displayed. When any boxes are selected from a box list displayed on the box list window, a document data list window illustrated in FIG. 5 is displayed.

FIG. 5 is a diagram illustrating a document data list window which displays, as a list, information about the document data stored in the box, which is selected from the box list window.

Document names are displayed on a document name column 401. Information indicating document types is displayed on a document type column 402. Data sizes of each document are displayed on a document size column 403. Information about last update date and time of each document is displayed on an updated date column 404. In addition, the total number of documents displayed on the document data list is displayed on the total document number column 412.

A detailed information display button 405 is used to display a window which allows the user to view more detailed information about the document selected from the document data list. A document detail window, which is displayed when the detailed information display button 405 is pressed shows a storage destination, a type, an expiration date, and owner data, of the document, or the like. These details of the document are included in the index associated with the document. Information included in the index will be described below in detail.

A print button 406 is used to display a setting window for printing the document data displayed as being selected. The send button 407 is used to display a setting window for transmitting the document data displayed as being selected, to other devices via a network such as a LAN or a PSTN.

A keyword search button 408 is used to search for a document satisfying a specified condition from the document data list. A process which is performed when the keyword search button 408 is pressed will be described below. A display button 409 is used to display a window which allows the user to view the contents of the document data displayed as being selected. A delete button 410 is used to delete the document data displayed as being selected, from the box area. A close button 411 is used to close the window.

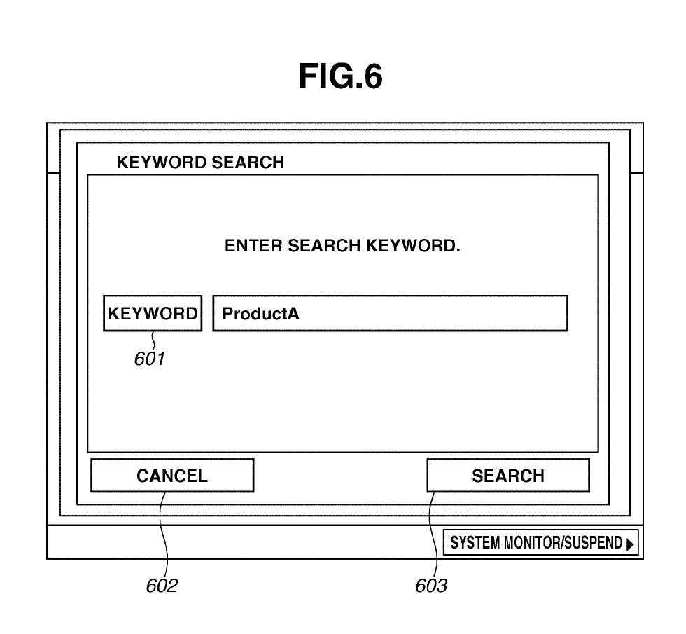

FIG. 6 is a diagram illustrating a keyword search specifying window, which is displayed when the keyword search button 408 illustrated in FIG. 5 is pressed.

A search keyword input button 601 is used to enter keywords to search for a desired document. When the search keyword input button 601 is pressed, a software keyboard is displayed on the window. This allows a user to enter a desired search keyword to make a search to find out whether any information matching with the entered keyword exists in the index 501 associated with the document image 502. A user specifies a keyword corresponding to the keyword information from the attribute data 504 included in the index 501. Here, it is assumed that “ProductA” is entered as a user-specified keyword. A cancel button 602 is used to close the window without carrying out any process. A search start button 603 is used to initiate search based on the entered keyword.

Although a keyword search is used as a document search method in this case, the present invention is not limited to such a search method using a keyword search. Instead, any search method can be used as long as a plurality of search results is present. For example, a method based on a document update period or an author may also be used.

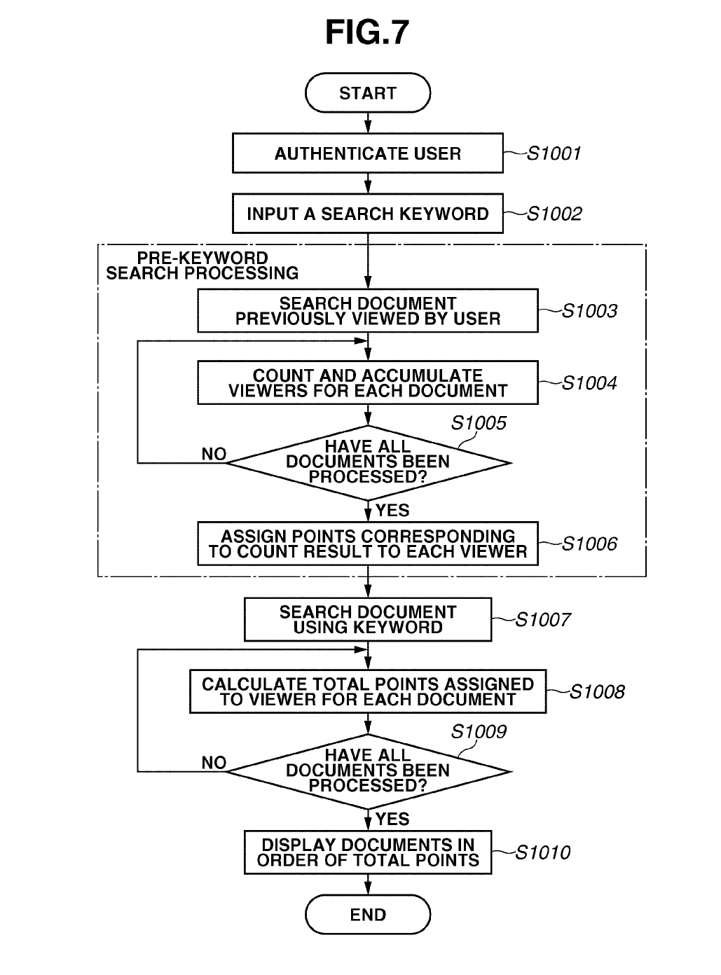

Now, a keyword search process according to the first exemplary embodiment will be described with reference to FIGS. 7, 8, and 9.

FIG. 7 is a flowchart illustrating a keyword search process according to the first exemplary embodiment. In this flowchart, operation control sequences are executed by the CPU 101 of the controller unit 100 based on a control program stored in the HDD 104.

First in step S1001, the CPU 101 executes a log-in process to authenticate a user. For example, a user management database in which users allowed to use the corresponding image processing apparatus are previously registered, or user information of the allowable users retained in an apparatus, may be used. More specifically, a user is prompted to enter a user ID and a password using the operation panel 202, and authentication is preformed using the user management database or the user information stored in the apparatus based on the entered information. If a user is authenticated and identified, then the process advances to step S1002. In addition, the authentication method is not limited to such a method using the user ID and password as described above, but other methods using biometric authentication or an IC card may also be used.

If a user is successfully authenticated as a result of step S1001, the CPU 101 executes keyword input operation in step S1002. In this operation, a user enters a document search keyword on the keyword search window illustrated in FIG. 6. If the keyword input operation is completed, and the search start button 603 is pressed, then the process of the CPU 101 advances to the processing preceding a keyword search in steps S1003 through S1006.

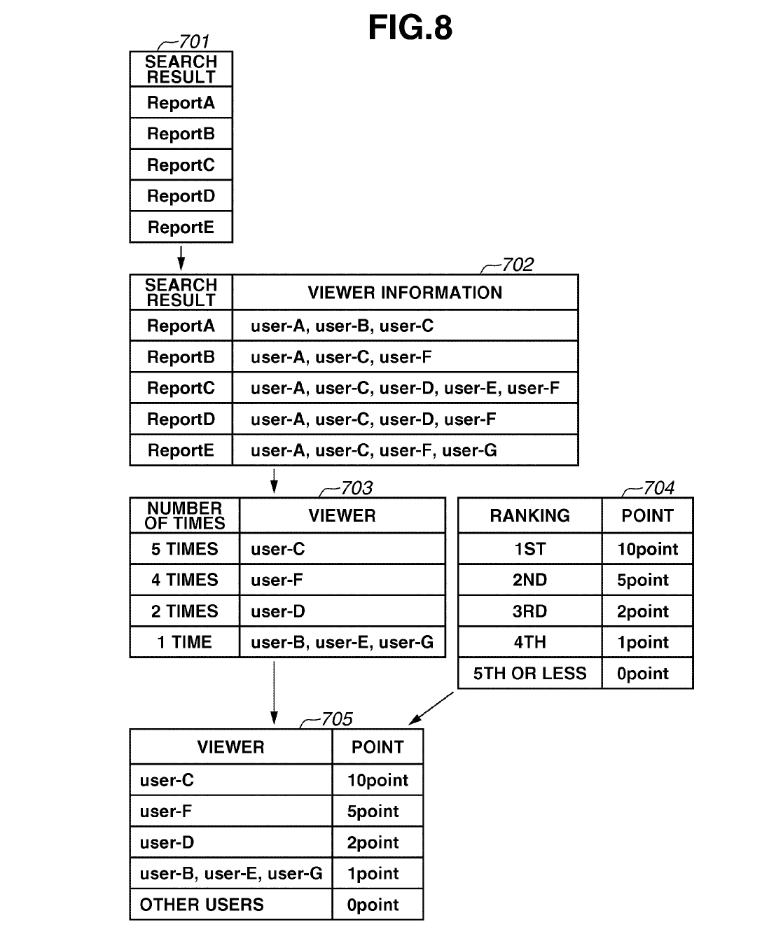

FIG. 8 is a conceptual diagram illustrating a data operation preceding the keyword search when the search start button 603 is pressed and the keyword search is initiated.

In this exemplary embodiment, the processing preceding the keyword search is executed before the keyword search is performed. In this pre-keyword search, the CPU 101 detects other users who have viewed many times the documents that have been viewed by the search user. This detection result is used as information to rank the result of the keyword search. In this example, the search user is a user-A.

In step S1003, the CPU 101 searches for the documents that have been viewed by the search user in the past from the index 501 stored in the HDD 104 based on the information about a log-in search user. As a result, data corresponding to the search result 701 is obtained. The data 701 illustrated in FIG. 8 contains the documents that have been viewed by the user-A (i.e., the search user), as a search result. These search results are obtained by the CPU 101 searching for the documents that have been viewed by the user-A in the past based on the user information 509 and the operation details information 508 in the index 501. In the example illustrated in FIG. 8, five documents, namely, ReportA, ReportB, ReportC, ReportD, and ReportE, are retrieved.

In step S1004, the CPU 101 obtains a list of viewers (i.e., access users) for each of the documents obtained in step S1003 based on the user information 509 and the operation details information 508 contained in the index 501. In other words, the CPU 101 obtains entire data of the user information 509 included in the index 501 with respect to the documents shown in the data 701. The obtained list of viewers is illustrated as data 702 in FIG. 8. As shown in the data 702, while the user-A has viewed all documents, other users also have viewed the corresponding documents. Further, the CPU 101 counts an accumulative number of times that the viewers appear, in step S1004.

Then, in step S1005, the CPU 101 determines whether the process of step S1004 has been completely performed for all documents obtained in step S1003. If it is determined that the process has not been performed for all of the documents (NO in step S1005), the process of step S1004 is repeated for unprocessed documents.

If it is determined that all of the documents have been processed in step S1005 (YES in step S1005), the process advances to step S1006. As a result, it is possible to obtain an accumulative number of times that each viewer appears, which is the data 703, for all of the documents obtained in step S1003.

More specifically, the CPU 101 counts the number of times that each of the users other than the user-A views the documents from the data 702, and sorts them in descending order of viewing times. The result thereof is illustrated in the data 703. Referring to this result, the number of times a user-C has viewed the documents is the highest. From this result, it is recognized that the user-C is a user who has viewed the same documents as those viewed by the user-A in the past.

In step S1006, the CPU 101 executes point allocation to each viewer based on the processing result corresponding to the aforementioned data 703 and based on the data 704 (illustrated in FIG. 8) associated with point allocation that has been previously determined. More specifically, points are allocated to users who have viewed the same documents as those viewed by the search user in the past in descending order of viewing times. The ranks and the points are shown in the data 704 illustrated in FIG. 8. This data 704 is previously determined. In this example, 10 points are allocated to the first rank, and then, points are allocated to each rank in sequence from the second rank to the fourth rank. However, the present invention is not limited to such allocation of the points.

Through the process of step S1006 (i.e., a user ranking process) information about the points of users, which is the data 705 illustrated in FIG. 8 can be obtained. More specifically, users having a higher number of times viewing the same document as those viewed by the search user (i.e., the user-A) in the past and points allocated to the users based on the data 703 and 704 are shown in the data 705 in FIG. 8.

In the example illustrated in FIG. 8, ten points are allocated to the user-C, and lower points are allocated to users F and D in this order. One point is equally allocated to the user-B, user-E, and user-G. Zero point is allocated to remaining users.

The more frequently a user has viewed the documents that are viewed by the user-A (i.e., a search user), the higher point the user can earn. This means that a user who has an interest or a taste similar to that of the user-A gets a higher point.

The process described above is a pre-process before a keyword search of the document (i.e., the processing preceding the keyword search). The result of the pre-keyword search is used when ranking of the search results obtained after the document keyword search is performed.

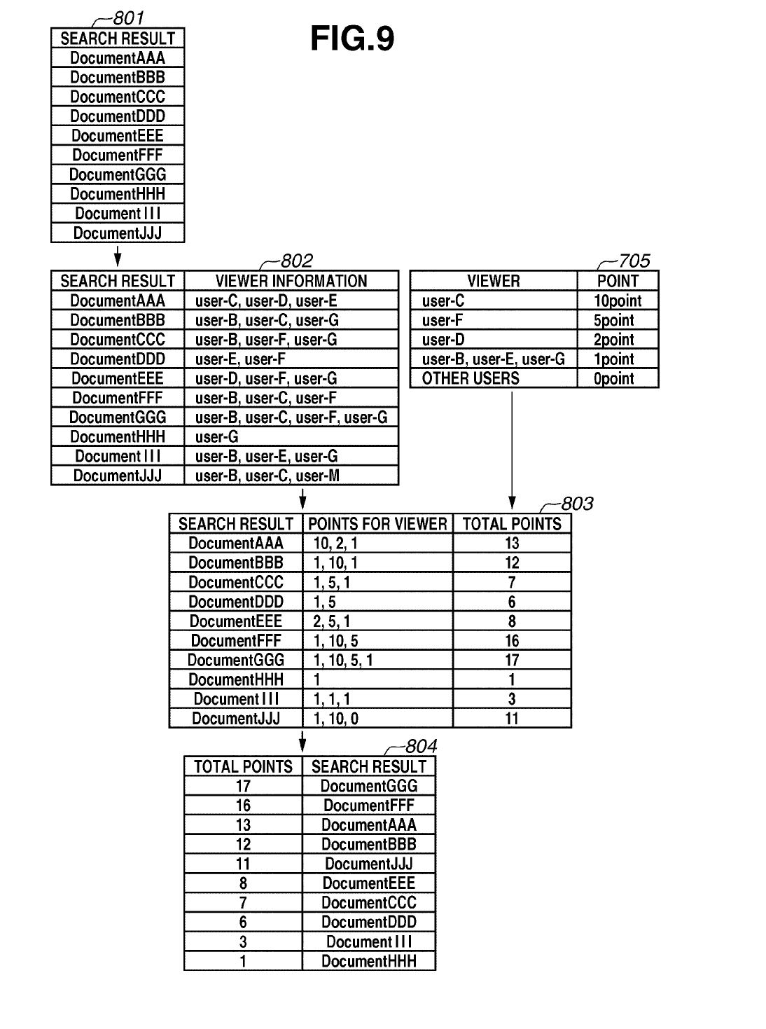

Now, keyword search performed in steps S1007 through S1010 in FIG. 7 will be described with reference to FIG. 9. FIG. 9 is a conceptual diagram illustrating an data operation in a ranking process for the search results of the keyword search.

In step S1007, the CPU 101 executes keyword search to the documents in the HDD 104 using the keyword input by a user in step S1002. As a result, search result data 801 as illustrated in FIG. 9 is obtained. More specifically, the keyword is specified via the search keyword input button 601 illustrated in FIG. 6. The search result data 801 is generated by the CPU 101, which searches for the index in the HDD 104 using the specified keyword and obtains the document associated with this index. In this example, ten documents DocumentAAA to DocumentJJJ are retrieved.

Then, in step S1008, the CPU 101 obtains viewer information using the user information 509 and the operation details information 508 in the index 501, based on the data obtained in step S1007. More specifically, user information 509 indicating the users who have in the past viewed each of the documents in the data 801 that are retrieved by the keyword search, is obtained from the index 501. This result is illustrated as data 802 in FIG. 9. In the data 802, information about the number of viewers is registered for each document. Furthermore, in step S1008, the CPU 101 calculates a total point of the viewers for each document based on the point allocation of each viewer obtained in step S1006.

Then, in step S1009, the CPU 101 determines whether the process of step S1008 has been performed for all of the documents obtained in step S1007. If it is determined that the process has not been performed for all documents (NO in step S1009), then the process of step S1008 is repeated for the unprocessed documents. If it is determined that the process of step S1008 has been performed for all documents in step S1009 (YES in step S1009), then the process advances to step S1010. As a result, viewer point data for the keyword search documents can be obtained, which is the data 803 illustrated in FIG. 9.

More specifically, the CPU 101 allocates points to each viewer according to the data 705 obtained in the previous process, and sums up the points for each document to obtain total points allocated to the viewers. The result of this process is illustrated as data 803. Since the points for each document are calculated based on points of the previous data 705, the point for the document increases when users who have an interest or a taste similar to the search user (i.e. the user-A), have viewed the document. More specifically, the document having a higher total point has a higher probability that it evokes the interest or the taste close to that of the search user (i.e., the user-A).

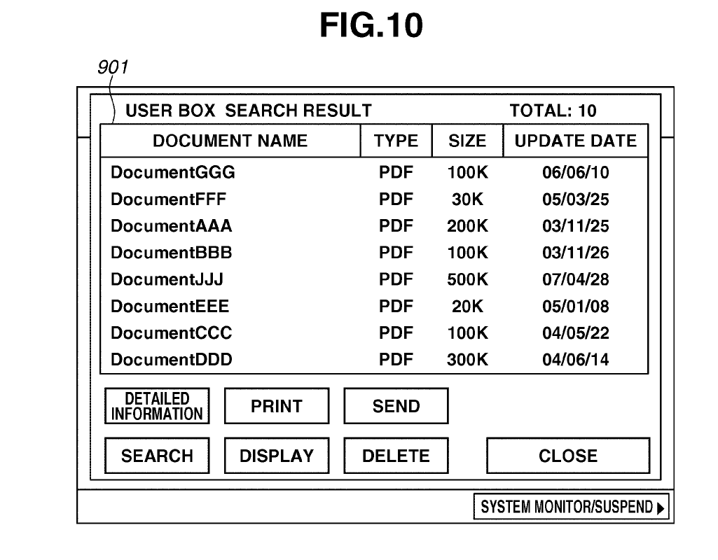

Then, in step S1010, the result of processing of the previous data 803 is sorted in descending order of the viewer point (i.e., a document ranking process). Thus, it is possible to obtain data 804 illustrated in FIG. 9. In other words, the data 804 is obtained by sorting the documents in order of the point based on the data 803. From this process, it is determined that the document DocumentGGG is the most interesting one for the user-A among the documents of the data 801 retrieved from the keyword search. Also, it is determined that the document DocumentHHH is the least interesting one. The CPU 101 displays the data 804 on the search result window illustrated in FIG. 10.

FIG. 10 is a diagram illustrating a window for displaying search results obtained after the keyword search is performed. This window has the same function as the document list window illustrated in FIG. 5.

Referring to FIG. 10, names of the documents retrieved as a result of the keyword search are displayed on a document name column 901. At the time, the document names are displayed in the same order as the previous data 804. Since the documents close to the user-A's interest are displayed in descending order of interests of the search user (i.e., the user-A), the user-A can possibly search out a desired document quickly, which improves search efficiency. The more a number of search results, the more effect can be achieved.

According to the first exemplary embodiment, all of the documents that have been viewed by a search user in the past are searched, and other users who have browsed those documents are determined to be users who have an interest or a taste similar to the search user. The user information is used in a process (steps S1008 and S1009) ranking the keyword search results, so that the document information resulting from the search can be displayed in order of the interest or taste of the search user.

In other words, the search results are ranked based on user information about users who have browsed the same documents as those browsed by the search user, so that the documents browsed by a user having a taste similar to the search user can be displayed in a higher rank of the search results. The search user has a high probability of quickly finding out a desired document from the search results. Therefore, it is possible to improve convenience in the document search.

Hereinafter, the second exemplary embodiment of the present invention will be described in detail.

According to the first exemplary embodiment, all of the documents viewed by the search user in the past are retrieved, and other users who have browsed those documents are determined to have an interest or a taste similar to the search user. However, according to the second exemplary embodiment, the search user specifies a time period in which documents have been viewed by him. By doing this, a range of users who have the interest or taste similar to the search user is narrowed to a certain time period, and then used to allocate ranks to the keyword search results.

Since a basic construction of the second exemplary embodiment is similar to the first exemplary embodiment, detailed description thereof will be not be repeated, except for the construction different from the first exemplary embodiment.

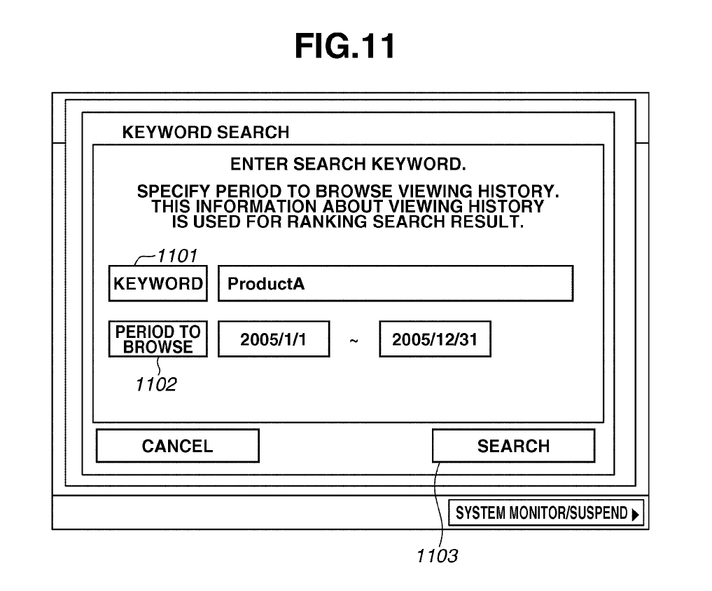

FIG. 11 is a diagram illustrating a keyword search specifying window according to the second exemplary embodiment.

This window is displayed when the keyword search button 408 illustrated in FIG. 5 is pressed similar to the keyword search specifying window illustrated in FIG. 6.

Referring to FIG. 11, a search keyword input button 1101 is used to select a keyword to search for a document. A browsing period specifying button 1102 is used to specify a period in which the documents were viewed by a search user in the past. The search user may specify a time period from a specific date and time to another specific date and time, or a period after or before a specific date and time using the browsing period specifying button 1102. The search user does not always have the same interests or tastes. Therefore, the browsing period may be specified in a case where a user wishes to rank keyword search results based on a specific past period of time, or recent interests and tastes.

A search start button 1103 is used to start the search based on the entered keyword and the selected browsing period.

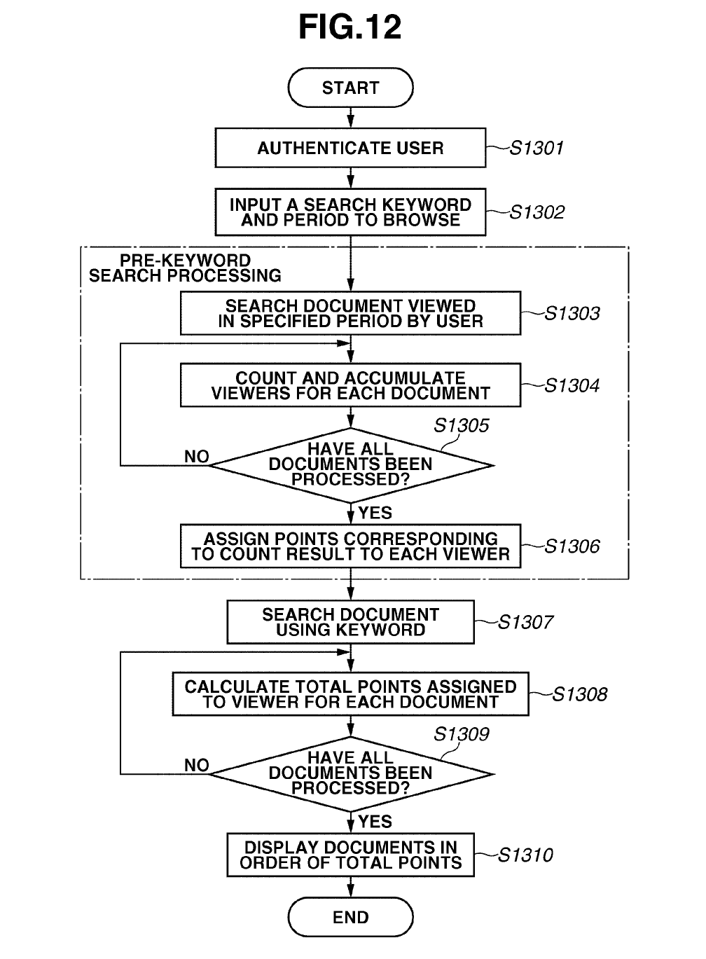

Now, a keyword search process according to the second exemplary embodiment will be described with reference to FIG. 12. FIG. 12 is a flowchart illustrating a keyword search process according to the second exemplary embodiment. Operation procedures in this flowchart is controlled by the CPU 101 of the controller unit 100 based on a program stored in the HDD 104.

Initially, the CPU 101 executes a log-in process for a user to authenticate the user in step S1301. This procedure is similar to step S1001 according to the first exemplary embodiment. If a user is successfully authenticated, the process advances to next step S1302, wherein the CPU 101 executes the following process. A keyword search window illustrated in FIG. 11 is displayed to execute a process of entering a keyword for search of a document and a browsing period of documents used to allocate ranks to the searched documents. A user can enter a search keyword and a browsing period on this keyword search window.

When the search keyword and the browsing period are entered, and the search start button 1103 is pressed, the process of the CPU 101 advances to subsequent pre-keyword search in steps S1303 to S1306.

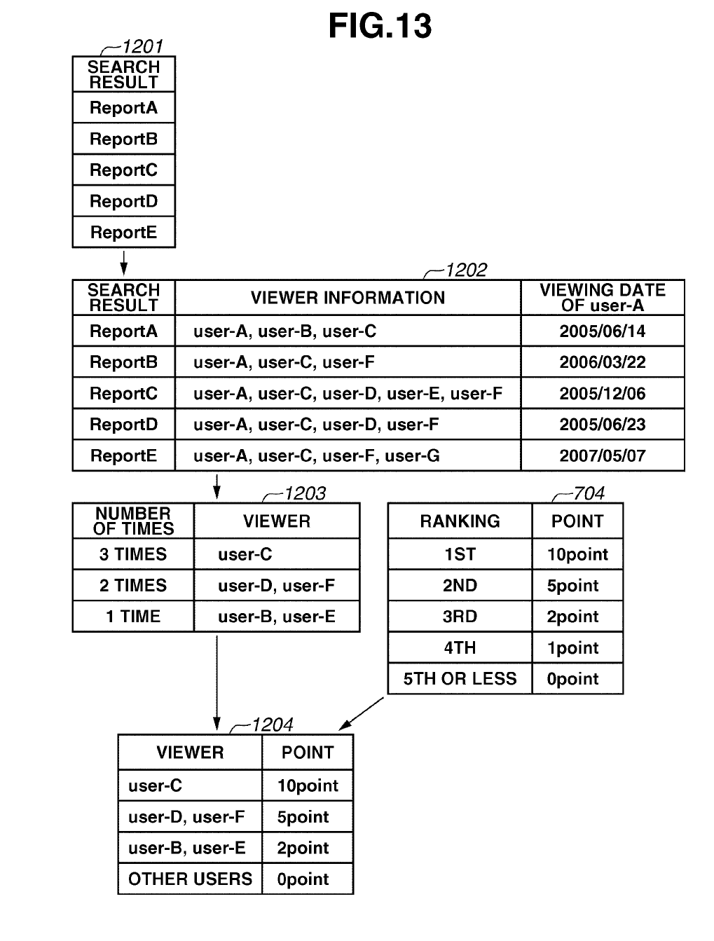

FIG. 13 is a conceptual diagram illustrating data operation in the processing preceding the keyword search when the search start button 1103 is pressed and the keyword search is initiated.

In the second exemplary embodiment, the CPU 101 similarly executes the proceeding preceding keyword search before the keyword search is executed.

In step S1303, documents that have been viewed by the search user during the browsing period are searched from the index 501 in the HDD 104 based on log-in information entered by the search user and the browsing period entered in step S1302. As a result, the search result 1201 illustrated in FIG. 13 is obtained. The data 1201 is search results of the documents that have been viewed by the search user (i.e., the user-A) in the past. This data 1201 is similar to the search result 701 illustrated in FIG. 8.

The process from step S1304 to step S1310 is basically similar to the process from step S1004 to step S1010 of the first exemplary embodiment, thus description will be made mainly as to the matters different from the first exemplary embodiment.

The data 1202 illustrated in FIG. 13 is obtained in step S1304. More specifically, data of all viewers is obtained from the documents indicated in the data 1201 based on the user information 509 in the index 501 and the operation detail information 508. Further, dates and times when the user-A browsed the documents are obtained based on the user information 509 and the date information 507. The obtained results are displayed as the data 1202.

Based on the browsing period specified by the button 1102 illustrated in FIG. 11, when the user-A browsed documents within the specified period, the documents are extracted from the data 1202. In this example, the specified browsing period is from Jan. 1, 2005 to Dec. 31, 2005 as shown in FIG. 11. As a result, three documents, namely, ReportA, ReportC, and ReportD satisfy this condition.

In addition, the data 1203 illustrated in FIG. 13 is obtained in step S1305. More specifically, the number of times the three documents satisfying this condition have been viewed by users other than the user-A is counted, and the users are sorted in descending order of the number of times. As a result, data 1203 is obtained as shown in FIG. 13.

The data 1203 corresponds to the data 703 of the first exemplary embodiment. However, since the period in which the search user (i.e., the user-A) browsed a document is reflected on the result, other users who have viewed many documents which were browsed by the user A during this time period, are ranked.

In addition, the data 1204 illustrated in FIG. 13 is obtained in step S1306. More specifically, the CPU 101 calculates the point in the data 1204 for each viewer as shown in FIG. 13 based on the data 1203 and point allocation 704 that is previously determined. The data 1204 corresponds to the data 705 of the first exemplary embodiment, and is used in step S1308 where each document is ranked after the keyword search is performed in step S1307.

The process of steps S1307 to S1310 illustrated in FIG. 12 of the second exemplary embodiment is similar to the process of steps S1007 to S1010 illustrated in FIG. 7 of the first exemplary embodiment, and its detailed description thereof will not be repeated here.

According to the second exemplary embodiment, it is possible to specify a browsing period of the documents that have been viewed by the search user. Thus, a time period during which the search user was interested in a specific matter is specified and a range of users who have an interest or a taste similar to the search user is narrowed. Then, information about such users are used when a ranking process is performed on the keyword search results in steps S1308 and S1309. Therefore, it is more likely that the documents resulting from the search are displayed in order of the interest or taste of the search user.

Thus, according to the second exemplary embodiment, users who have browsed the same documents as those browsed by the search user can be limited by narrowing the past browsing period. As a result, it is possible to display the documents browsed by users who have the interest or taste similar to the search user in a higher rank in the search result. Therefore, convenience of the document search can be improved.

Now, the third exemplary embodiment of the present invention will be described.

According to the first exemplary embodiment, all documents that have been viewed by a search user in the past are retrieved, and other users who have browsed the searched documents are determined to be users who have an interest or a taste similar to the search user.

In contrast, according to the third exemplary embodiment, firstly, it is determined what kind of operation is going to be executed by the search user for the documents to be searched. Then, it is determined that the users who have executed the same operation for the same documents as those that the search user has executed in the past, have an interest or a taste similar to the search user.

Since a basic construction of the third exemplary embodiment is similar to that of first exemplary embodiment, detailed description thereof will not be repeated here. Only the matters different from the first and second exemplary embodiments will be described.

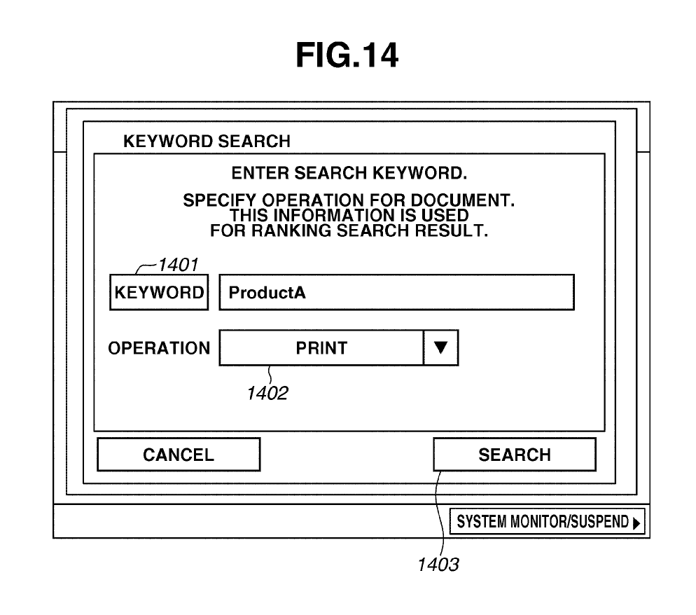

FIG. 14 is a diagram illustrating a keyword search specifying window according to the third exemplary embodiment.

Similar to the keyword search specifying window illustrated in FIG. 6, the window in the present exemplary embodiment is displayed by pressing the keyword search button 408 illustrated in FIG. 5.

Referring to FIG. 14, a search keyword input button 1401 is used to specify a keyword used in searching for a document. A document operation specifying button 1402 is used to specify what kind of operation should be executed for the documents that have been searched by the user. Operation for the documents includes view (display), print, send operation or the like. In this example, “print” is specified as the operation for the documents.

These operations correspond to the display button 409, the print button 406, and the send button 407 in FIG. 5. Therefore, if the operation executed by a user for the documents can be selected in advance by pressing these buttons, operation may be specified based on the selected button.

By determining what kind of operation will be executed by a user for the documents, users who executes the same operation for the same documents as those the search user has executed in the past are extracted as the users who have an interest or a taste similar to the search user, and ranks are allocated to them. Furthermore, ranking is performed on keyword search results based on the information about those users.

A search start button 1403 is used to start search based on the entered keyword and the specified document operation.

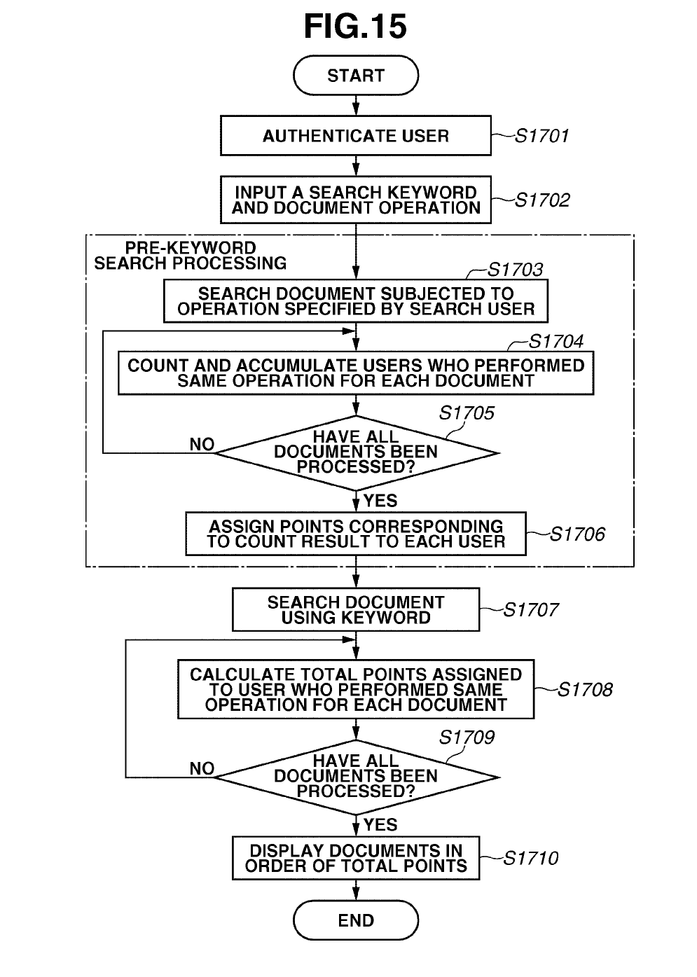

Now, a keyword search process according to the third exemplary embodiment will be described with reference to FIG. 15. FIG. 15 is a flowchart illustrating a keyword search process according to the third exemplary embodiment. Operation control procedures illustrated in this flowchart are executed by the CPU 101 of the controller unit 100 based on a program stored in the HDD 104.

Firstly, the CPU 101 executes a log-in of a user to authenticate the user in step S1701. This process is similar to step S1001 of the first exemplary embodiment. If the user is successfully authenticated, the CPU 101 displays a keyword search window illustrated in FIG. 14 in order to specify a keyword used to search for documents and operation for the searched documents in the subsequent step S1702. A user is allowed to enter a search keyword and specify operation for the documents on the keyword search window.

When the search keyword is entered, the operation for the documents is specified, and the search start button 1403 is pressed, the process of the CPU 101 advances to the processing preceding keyword search in steps S1703 to S1706.

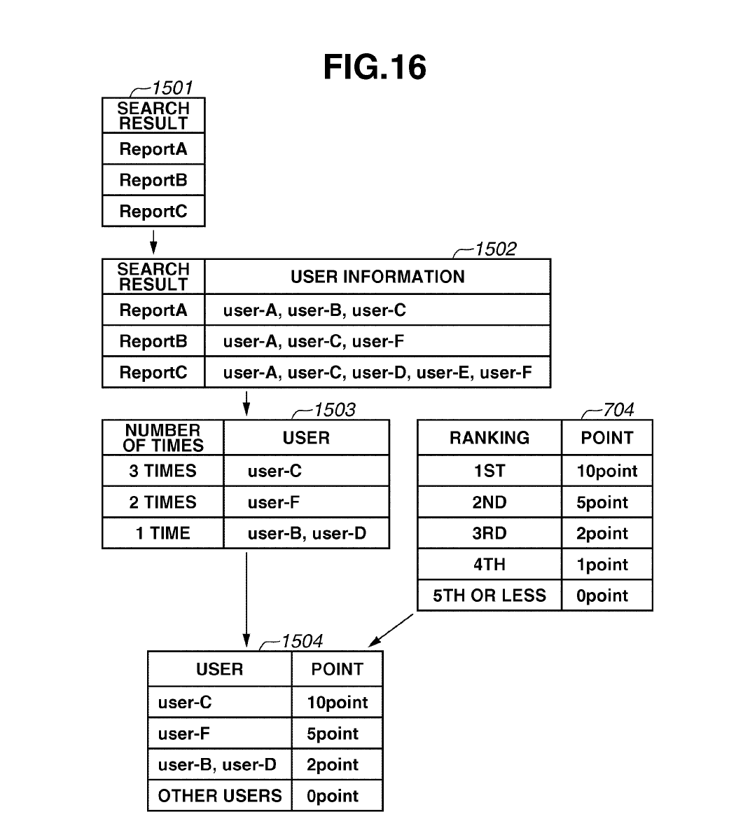

FIG. 16 is a conceptual diagram illustrating data operation in the processing preceding keyword search when the search start button 1403 is pressed and the keyword search is initiated.

In step S1703, the CPU 101 searches for the documents, to which the operation selected by the search user has been executed, from the HDD 104 based on log-in information of the search user and information on specified document operation input in step S1702. Data 1501 illustrated in FIG. 16 includes the search results of the documents that have been printed by the search user (i.e., the user-A) in the past. This data includes the search results of the documents, to which the operation specified by the search user (i.e., the user-A) using the document operation specifying button 1402 has been executed, based on the user information 509 and the operation content information 508 in the index 501. In this example, three documents ReportA to ReportC are retrieved.

Further, in step S1704, the CPU 101 specifies other users, who have executed the operation specified in step S1702 to the documents retrieved in step S1703, based on the user information 509 and the operation content information 508 in the index 501. More specifically, the CPU 101 acquires information about all users who have executed the same operation as specified by the document operation specifying button 1402, to the documents included in the data 1501 based on the user information 509 and the operation content information 508 in the index 501 of each document. More specifically, the CPU 101 identifies all users who have printed the documents included in the data 1501. As a result, data 1502 illustrated in FIG. 16 is obtained. In addition, the number of times the documents were printed is calculated for each user.

Subsequently, in step S1705, the CPU 101 determines whether the process of step S1704 has been executed to all of the documents retrieved through step S1703. It is possible to obtain a processing result corresponding to the data illustrated in FIG. 16 by executing the process of step S1704 to all of the documents. More specifically, the users other than the user-A listed in the data 1502 are sorted in descending order of the number of times the document is printed. Thus, the data 1503 is obtained. Since the user-C has the most frequently printed the documents that were printed by the search user (i.e., the user-A), it is determined that the user-C has an interest or a behavior pattern similar to the user-A.

Subsequently, in step S1706, the CPU 101 allocates points to each user based on the processing result of the data 1503 and point allocation 704 that has been previously determined. As a result, it is possible to obtain a processing result of data 1504 illustrated in FIG. 16. In other words, the data 1504 is obtained by determining points of each user based on the point allocation 704 that has been previously determined.

The process described hereinbefore is a pre-process (i.e., the processing preceding keyword search) for the keyword search of document. The result of this process is used when a ranking process is performed on the search results obtained after the keyword search of document is executed.

The process of steps S1707 to S1710 is basically similar to the process of steps S1007 to S1010 of the first exemplary embodiment.

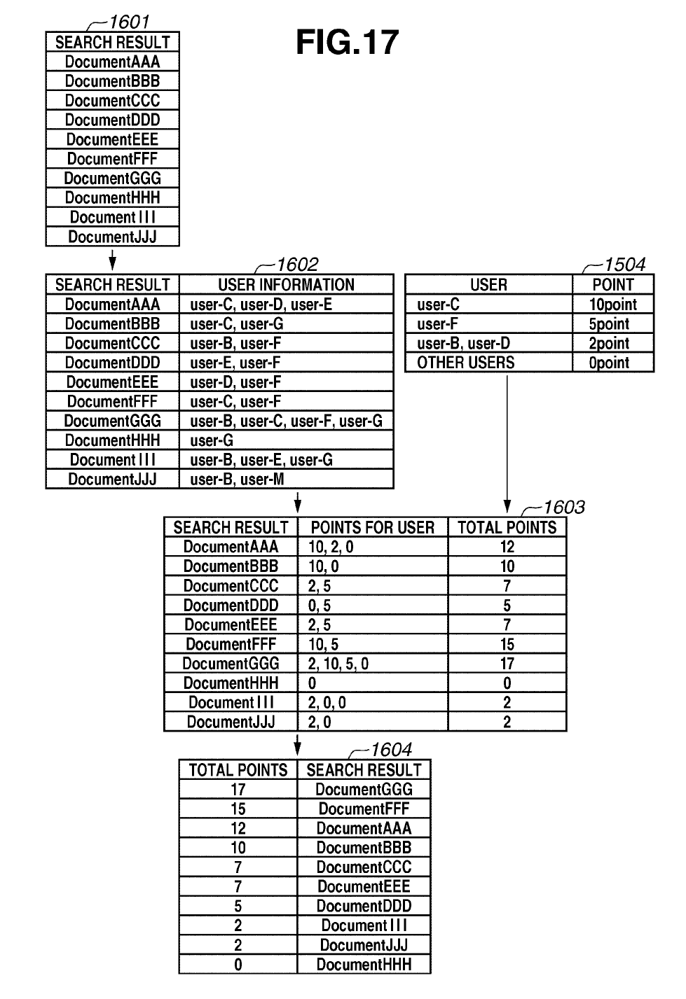

Now, a keyword search process S1707 to S1710 will be described with reference to FIG. 17. FIG. 17 is a conceptual diagram illustrating data operation executed in a ranking process to the search results.

In step S1707, the CPU 101 executes keyword search for the documents in the HDD 104 based on the keyword entered by a user through step S1702. As a result, data corresponding to the search result data 1601 illustrated in FIG. 17 is obtained. More specifically, the CPU 101 searches for the index stored in the HDD 104 (i.e., an index search process) based on the keyword specified with the search keyword input button 1401 illustrated in FIG. 14 so as to retrieve the documents associated with the index and obtain the data 1601. In this example, ten documents, DocumentAAA to DocumentJJJ, are retrieved.

Subsequently, in step S1708, the CPU 101 obtains information about users who have printed each of the documents listed in the data 1601 which are retrieved by the keyword search based on the user information 509 and the operation details information 508 in the index 501. The users dealt with in step S1708 are those who have executed the operation specified with the document operation specifying button 1402. Thus, data 1602 is obtained as illustrated in FIG. 17. Further, in step S1708, a total point, which is a sum of the points allocated in step S1706 to the users who have executed the operation selected in step S1702, is calculated for each of the documents obtained in step S1707. More specifically, points of each user are obtained based on the data 1602 and the data 1504 obtained in the pre-process for each document. The points of each document are calculated to obtain the data 1603 illustrated in FIG. 17.

In step S1710, the documents are sorted in descending order of the points to obtain the data 1604 illustrated in FIG. 17, and the CPU 101 displays the documents resulting from the search, on an operation panel 202.

According to the third exemplary embodiment, a range of other users having an interest or a taste similar to the search user is narrowed by specifying operation for the documents to be searched by a search user. Information about the other users is used to perform a ranking process on the keyword search results in steps S1708 and S1709. Thus, it is more likely that the documents resulting from the search are displayed in order of degree of the interest or taste that matches with that of the search user.

More specifically, a ranking process is performed on the search results based on information about users who have executed the same operation for the same documents as those performed by the search user in the past. As a consequence, the documents handled by the users who have a behavior history similar to the search user are displayed in a higher rank of the search results. Thus, it is possible to improve convenience of the document search.

The object of the present invention may also be achieved by executing the following process. A storage medium recording software program codes that implement functions of the aforementioned exemplary embodiments may be supplied to a system or device, and program codes stored in the storage medium may be read from a computer (e.g., CPU or micro processing unit (MPU)) of the system or device.

In this case, the program codes themselves read from the storage medium implement functions of the aforementioned exemplary embodiments. Accordingly, these program codes or any storage medium storing the program codes constitutes the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-129492 filed May 16, 2008, which is hereby incorporated by reference herein in its entirety.

What is claimed is:

1. An information processing apparatus comprising:
a storage unit configured to store document information;
a holding unit configured to hold a plurality of indices associated with each document information stored in the storage unit, each of the indices including history information describing user information about users who have accessed each document information;
an input unit configured to allow a user to input information;
a user ranking unit configured to allocate ranks to users, who have accessed the document information that have been accessed by the search user in the past, based on the history information included in a plurality of the indices;
an index search unit configured to search the index held by the holding unit based on a keyword specified by the search user using the input unit; and
a document ranking unit configured to allocate ranks to the document information associated with the index which is retrieved by the index search unit, based on the user information about the access users in the index retrieved by the index search unit, and the user information about the users ranked by the user ranking unit.

2. The information processing apparatus according to claim 1, wherein the history information further includes information about date and time that the search user and the access users have accessed information of the document, and
wherein the user ranking unit searches for the document information that has been accessed by the search user for a certain time period in the past, and allocates ranks to the access users who have accessed the retrieved document information, based on user information about the access users and date and time information included in the index.

3. The information processing apparatus according to claim 1, wherein the user ranking unit counts the number of times that the access users have accessed the document information that have been accessed by the search user in the past, and allocates previously determined points to each access user in order of the number of times, so as to allocate ranks to the access users and
wherein the document ranking unit allocates the points to each of the access users in the user information included in the index, which are retrieved by the index search unit, sums up the points for each index to obtain a total point for each index, and allocates ranks to the document information associated with the index in descending order of the total point.

4. An information processing apparatus comprising:
a storage unit configured to store document information;
a holding unit configured to hold a plurality of indices associated with each document information stored in the storage unit, each of the indices including user information identifying users who have accessed each document information and history information describing information about operation details performed by the users of the user information on the document information;
an input unit configured to allow a search user to input information;
a determination unit configured to determine the operation executed by the search user to the document information;
a user ranking unit configured to allocate ranks to the access users who have executed the same operation to the document information which the search user has performed in the past and which has been determined by the determination unit, based on the history information included in the indices;
an index search unit configured to search the index held in the holding unit based on the keyword specified by the search user using the input unit; and
a document ranking unit configured to allocate ranks to the document information associated with the index retrieved by the index search unit based on user information that is obtained by searching for the access users who have executed the same operation as those determined by the determination unit, with respect to the history information included in the index retrieved by the index search unit, and user information obtained by the user ranking unit.

5. The information processing apparatus according to claim 4, wherein the user ranking unit counts the number of times that each of the access users has executed to the document information the same operation which the search user has performed in the past and has been determined by the determination unit, and allocates ranks to the access users by allocating previously determined points in descending order of the number of times, and
wherein the document ranking unit allocates the points to each of the access users in the user information included in the index retrieved by the index search unit, sums up the points for each index to obtain a total point of each index, and allocates ranks to the document information associated with the index in descending order of the total point.

6. A method of controlling an information processing apparatus having a storage unit configured to store document information, a holding unit configured to hold a plurality of indices associated with each document information stored in the storage unit, each of the indices including history information describing user information about users who have accessed each document information, and an input unit configured to allow a search user to input information, the method comprising:
allocating ranks to access users, who have accessed the document information that have been accessed by the search user in the past, based on history information included in a plurality of indices;
searching the index held in the holding unit based on a keyword specified by the search user using the input unit; and
allocating ranks to the document information associated with the retrieved index based on user information about the access users included in the retrieved index and information about the ranked users.

7. A method of controlling an information processing apparatus having a storage unit configured to store document information, a holding unit configured to hold a plurality of indices associated with each document information stored in the storage unit, each of the indices including user information identifying users who have accessed each document information and history information describing information about operation details performed by the users of the user information on the document information, and an input unit configured to allow a search user to input information, the method comprising:
determining the operation executed by the search user to the document information;
allocating ranks to the access users, who have executed to the document information the same operation which the search user has executed in the past, and is determined by the determination unit, based on the history information included in the indices;
searching the index held in the holding unit based on a keyword specified by the search user using the input unit;
allocating ranks to the document information associated with the retrieved index based on user information obtained by searching for the access users who have executed the same operation as the determined operation, with respect to the history information included in the retrieved index, and user information obtained by the ranking.
